(19) United States
(12) Patent Application Publication
(10) Pub. No.: US 2014/0016029 A1
(43) Pub. Date: Jan. 16, 2014

(54) IMAGE CAPTURE DEVICE AND MASK STRUCTURE THEREOF

(71) Applicant: YU-CHENG HUANG, Taichung City (TW)

(72) Inventor: YU-CHENG HUANG, Taichung City (TW)

(73) Assignee: ALTEK CORPORATION, Hsinchu (TW)

(21) Appl. No.: 13/588,604

(22) Filed: Aug. 17, 2012

(30) Foreign Application Priority Data
Jul. 13, 2012 (TW) 101125225

(51) Int. Cl. H04N 5/225

(52) U.S. Cl. 348/375; 348/E05.026

(57) ABSTRACT

This invention discloses an image capture device and a mask structure thereof. The image capture device comprises a casing, a hinge module and an adapter. The hinge module is disposed in the casing. One end of the hinge module sticks out of the casing. One end of the adapter is disposed on the end of the hinge module, and a tripod tapped hole is disposed near another end of the adaptor. When the adaptor moves from a first position to a second position, the image capture device is set on a tripod by the tripod tapped hole. By such arrangements, the invention can effectively reduce volume, in order to achieve the objective of the product miniaturization.

### CROSS-REFERENCE TO RELATED APPLICATION

This application claims the benefit under 35 U.S.C. §119 of Taiwanese Patent Application No. 101125225, filed Jul. 13, 2012, which is hereby incorporated by reference in its entirety.

### BACKGROUND

1. Field of the Invention

The present invention relates to an image capture device and a mask structure thereof, in particular to the image capture device and the mask structure thereof connected onto a tripod.

2. Description of Related Art

As digital technological era arrives, people would like to record current matters in a trip by an image capture device. When shooting a scenic photo or taking a group photo, users generally set up a tripod to install the image capture device at a desired position to facilitate shooting the photos. Therefore, most image capture devices come with a tripod tapped hole for screwing and mounting the image capture device onto the tripod.

Most conventional tripod tapped holes are formed inside the image capture device directly. To securely screw and mount the image capture device onto the tripod, the tripod tapped hole usually has a specific depth (such as 6 mm to 7 mm) which is a big issue for the compact design of the image capture device. In addition, an interior space of the image capture device must be reserved for the tripod tapped hole, and thus increasing the level of difficulty for the spatial layout of the remaining components of the image capture device.

To achieve the compact design, some image capture devices do not come with any tripod tapped hole. When a user wants to use the tripod, the user requires a clamping module to clamp the image capture device before screwing and mounting the image capture device onto the tripod. However, the user has to carry the clamping module additionally, and thus causing inconvenience to the user. Furthermore, the clamping module cannot be integrated with the image capture device, so that there is a possibility of missing or losing the clamping module easily.

In summation of the aforementioned problems, the inventor of the invention designed and developed an image capture device and a mask structure thereof to overcome the problems of the prior art and enhance practical applications.

### BRIEF SUMMARY

In view of the aforementioned problems of the prior art, it is a primary objective of the present invention to provide an image capture device and a mask structure thereof to overcome the problem of a conventional image capture device that cannot be miniaturized easily.

To achieve the aforementioned objective, the present invention provides an image capture device comprising a casing, a hinge module and an adapter. The hinge module is installed in the casing, and an end of the hinge module sticks out of the casing. An end of the adapter is disposed at an end of the hinge module, and a tripod tapped hole formed proximate to the other end of the adapter. When the adapter moves from a first position to a second position, the image capture device can be screwed and mounted onto a tripod through the tripod tapped hole.

Preferably, the image capture device further comprises a decorative cover having a through hole corresponding to the tripod tapped hole; the decorative cover is installed to a side of the adapter, wherein the decorative cover and the casing are disposed on opposite sides of the adapter respectively.

Preferably, the decorative cover includes a blocking cover movably and pivotally installed to a side screwed and coupled to the tripod, and the blocking cover has a shape corresponding to the shape of the through hole.

Preferably, the image capture device further comprises an image capture button installed on a side of the casing; wherein the hinge module and the image capture button are disposed on the same side of the casing.

Preferably, the casing has a recession, and the adapter is situated at the recession when the adapter is situated at the first position.

Preferably, when the adapter is situated at the first position, the tripod tapped hole is situated on an inner side of the casing; and when the adapter is situated at the second position, the tripod tapped hole is situated at an outer side of the casing.

To achieve the aforementioned objective, the present invention further provides a mask structure applied in an image capture device, and the mask structure comprises a hinge module and an adapter. The hinge module is installed in the image capture device and disposed proximate to an input/output module of the image capture device, and an end of hinge module sticks out of the image capture device. An end of the adapter is disposed at an end of the hinge module and has a tripod tapped hole formed proximate to the other end. When the adapter moves from a first position to a second position, the image capture device can be screwed and coupled to a tripod through the tripod tapped hole. When the adapter is situated at the first position, the adapter covers the input/output module.

Preferably, the mask structure comprises a decorative cover having a through hole corresponding to the tripod tapped hole, wherein the decorative cover is installed on a side of the adapter, and the decorative cover and the image capture device are disposed on opposite sides of the adapter respectively, and the decorative cover can be screwed and coupled to a side of the tripod for movable and pivotally installing a blocking cover, and the blocking cover has a shape corresponding to the shape of the through hole.

Preferably, the hinge module is installed on a side inside the image capture device and disposed on the same side of an image capture button of the image capture device.

Preferably, the image capture device has a recession formed proximate to the input/output module. When the adapter is situated at the first position, the adapter is situated at the recession.

In summation, the image capture device and the mask structure thereof according to the present invention have one or more of the following advantages:

(1) The image capture device and the mask structure thereof can form the tripod tapped hole on the adapter in order to reduce the space required by the components in the image capture device effectively, so as to meet the requirements of a compact design of the product.

(2) The image capture device and the mask structure thereof can use the adapter to cover the input/output module, so as to achieve the effect of providing a consistent appearance to improve the aesthetic design.

### BRIEF DESCRIPTION OF THE DRAWINGS

FIG. 1 is a first schematic view of an image capture device in accordance with a first preferred embodiment of the present invention;

FIG. 2 is a second schematic view of an image capture device in accordance with the first preferred embodiment of the present invention;

FIG. 3 is a first schematic view of an image capture device in accordance with a second preferred embodiment of the present invention;

FIG. 4 is a second schematic view of an image capture device in accordance with the second preferred embodiment of the present invention;

FIG. 5 is a first schematic view of an image capture device in accordance with a third preferred embodiment of the present invention; and

FIG. 6 is a second schematic view of an image capture device in accordance with the third preferred embodiment of the present invention.

### DETAILED DESCRIPTION

The technical characteristics of the present invention will become apparent with the detailed description of the preferred embodiments accompanied with the illustration of related drawings as follows. It is noteworthy to point out that the drawings are provided for the purpose of illustrating the present invention, but they are not necessarily drawn according to the actual scale, or are not intended for limiting the scope of the invention.

The image capture device of the present invention can be any portable electronic device with an image capture function such as a camera, a digital camera, a camera phone, a Smartphone, a digital video camera or a tablet PC, and the digital camera is used as an example for the purpose of illustrating the present invention, but not intending for limiting the scope of the invention.

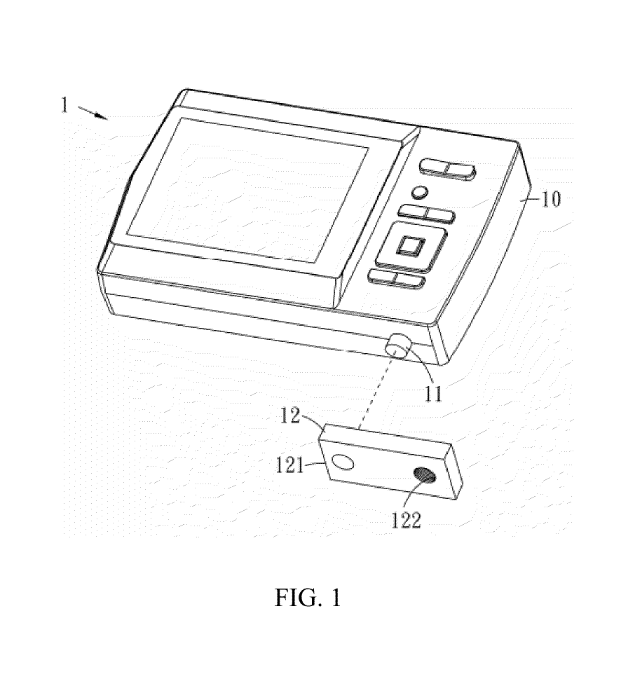

With reference to FIG. 1 for the first schematic view of an image capture device in accordance with a first preferred embodiment of the present invention, the image capture device 1 comprises a casing 10, a hinge module 11 and an adapter 12. The casing 10 is provided for covering components (such as the processing module and an image sensing element) of the image capture device 1. The hinge module 11 is installed in the casing 10 and an end of the hinge module sticks out of the casing 10, and a body or the other end of the hinge module 11 is fixed inside the casing 10. The adapter 12 is a plate structure which is a thin plate made of metal. An end 121 of the adapter 12 is disposed at an end of the hinge module 11, and the adapter 12 has a tripod tapped hole 122 formed proximate to the other end of the adapter 12. The image capture device 1 is screwed and coupled onto a tripod through the tripod tapped hole 122.

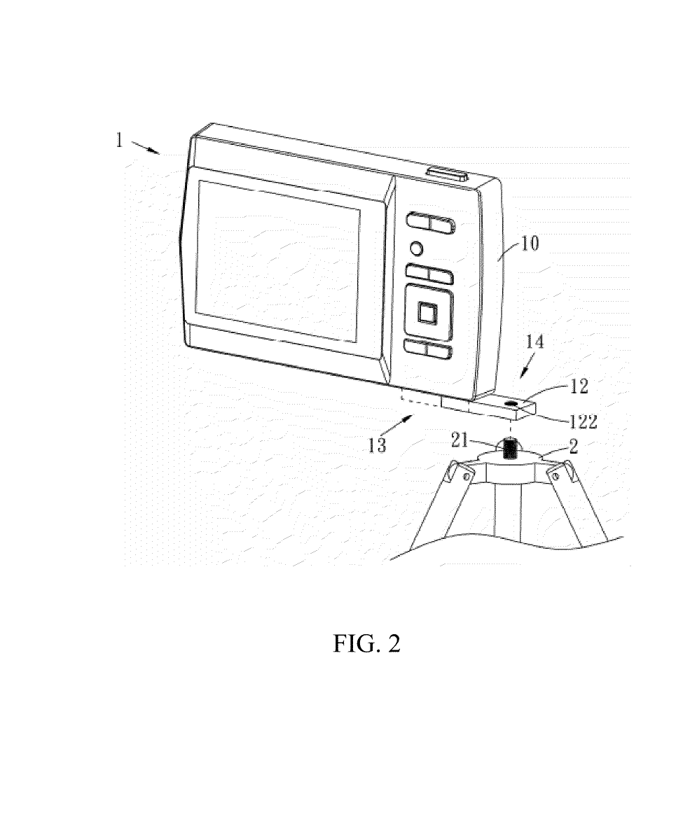

With reference to FIG. 2 for the second schematic view of an image capture device in accordance with the first preferred embodiment of the present invention, the adapter 12 is coupled to the image capture device 1 through the hinge module 11, and can move selectively at a first position 13 and a second position 14 by the design of a rotating mechanism of the hinge module 11. When the adapter 12 moves from the first position 13 to the second position 14, the adapter 12 rotates by using the hinge module 11 as the center. When the adapter 12 is situated at the second position 14, a stud 21 of the tripod 2 is passed through and screwed and coupled to the tripod tapped hole 122, so that the image capture device 1 can securely installed onto the tripod 2. It is noteworthy that the hinge module 11 can be a general hinge mechanism, or a general hinge used for a clamshell mobile phone or a notebook computer. These hinges are prior art, and thus will not be described in details.

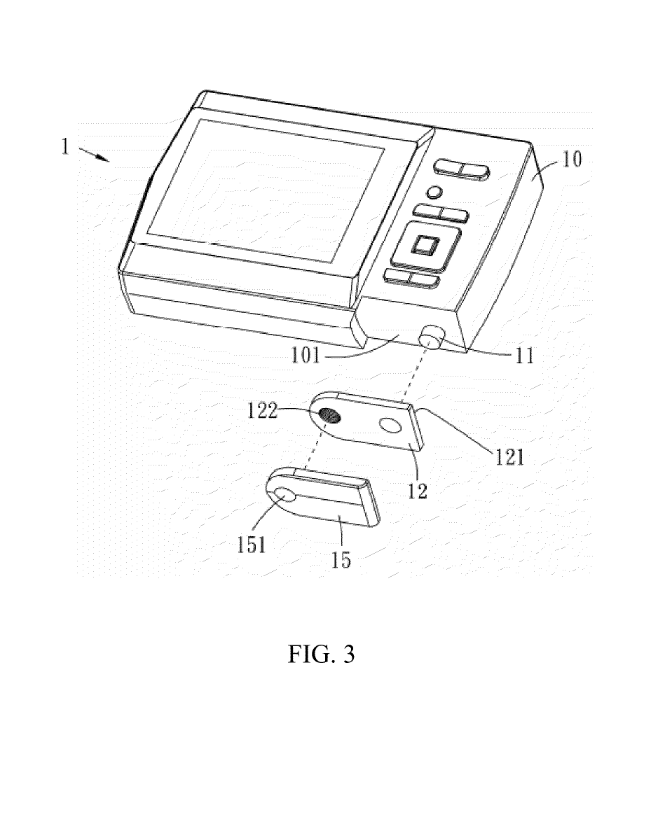

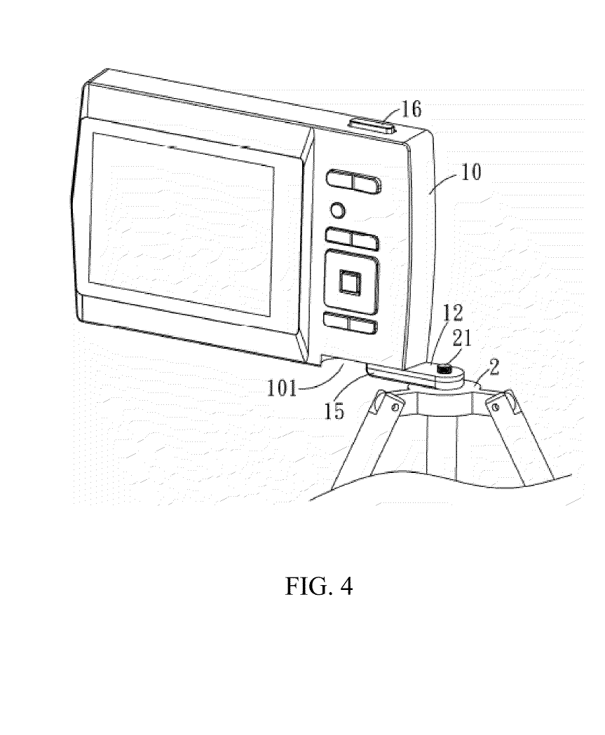

With reference to FIGS. 3 and 4 for the first and second schematic views of an image capture device in accordance with the second preferred embodiment of the present invention respectively, this preferred embodiment is similar to the foregoing preferred embodiment, so that the similar part will not be repeated. In the figures, the image capture device 1 of this preferred embodiment comprises a casing 10, a hinge module 11, an adapter 12, a decorative cover 15 and an image capture button 16. Wherein a recession 101 is formed on an outer surface of a side of the casing 10. An image capture button 16 is provided for users to press in order to control the image capture operation of the image capture device 1. The image capture button 16 is installed on a side of the casing 10 and disposed on the same side of the recession 101. On the other hand, the hinge module 11 is also installed on the same side and disposed between the image capture button 16 and the recession 101, sticks out the casing 10 from the bottom of the recession 101 and couples to the adapter 12. The decorative cover 15 is installed on a side of the adapter 12, wherein the decorative cover 15 and the casing 10 are disposed on both sides of the adapter 12 respectively. The decorative cover 15 has a through hole 151 corresponding to the tripod tapped hole 122 for passing the stud 21 through the through hole 151 and screwing and coupling to the tripod tapped hole 122.

When the adapter 12 is situated at the first position 13, both the adapter and the decorative cover 15 are situated in the recession 101, so that the overall appearance of the image capture device 1 is consistent. In a preferred mode, the adapter 12, the decorative cover 15 or the combination of the both has a shape corresponding to the shape of the recession 101, and the outer surface of the decorative cover 15 and the outer surface of the casing 10 have the same surface treatment or the same color (such as the etching and spray paint, etc), so that the overall appearance of the image capture device 1 is consistent. In addition, a dust blocking cover made of a soft material (such as rubber) is installed onto a side of the decorative cover 15 screwed and coupled to the stud 21 for movably covering the through hole 151 by an abutting or latching method, such that when the tripod tapped hole 122 is not in use, the tripod tapped hole 122 is covered to achieve an aesthetic appearance and a dustproof effect.

In addition, when the adapter 12 is situated at the first position 13, the tripod tapped hole 122 is situated on an inner side of the casing 10; and when the adapter 12 is situated at the second position 14, the tripod tapped hole 122 is rotated together with the adapter 12 to an outer side of the casing 10. Now, the stud 21 can be passed through the through hole 151 and screwed and coupled to the tripod tapped hole 122. Since the tripod tapped hole 122 is linked to the outer side of the casing 10, and the front end of the stud 21 can be screwed and coupled to the bottom of the stud 21, so that the connection can be completed with an appropriate number of teeth.

When the front end of the stud 21 is screwed and coupled to the bottom of the stud 21, a loading support portion of the tripod 2 provides a stable load carrying function of the image capture device 1 to further inhibit the image capture device 1 from being shaken.

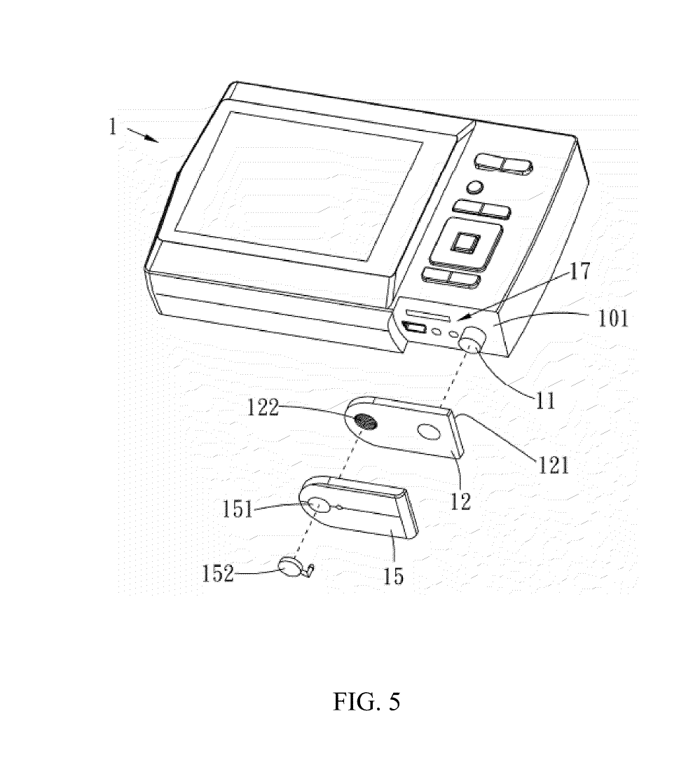

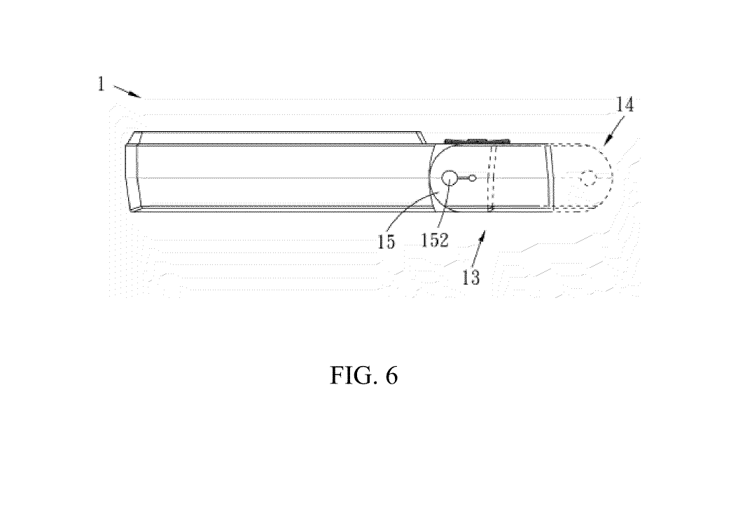

With reference to FIGS. 5 and 6 for the first and second schematic views of an image capture device in accordance with the third preferred embodiment of the present invention respectively, this preferred embodiment is similar to the aforementioned preferred embodiments, and the similar part will not be repeated. The image capture device 1 of this preferred embodiment comprises an input/output module 17 provided for transmitting information between the image capture device 1 and other electronic devices, or connecting the image capture device 1 to utility power or a charging device for transmitting power. The image capture device 1 has a recession 101 formed at a position corresponding to the input/output module 17, and a connecting surface of the input/output module 17 is disposed at the bottom of the recession 101. The input/output module 17 comprises a universal serial bus (USB), a power port or an erasable memory port.

The image capture device 1 has a mask structure comprising a hinge module 11, an adapter 12 and a decorative cover 15. In the image capture device 1 the hinge module 11 is installed at a position corresponding to the input/output module 17, and an end of the hinge module 11 sticks out of the image capture device 1 from the bottom of the recession 101. The adapter 12 has a shape corresponding to the shape of the recession 101, and the adapter 12 is coupled to the end of the hinge module 11 and has a tripod tapped hole 122. The decorative cover 15 has a shape corresponding to the shape of the recession 101 and a through hole 151 corresponding to the tripod tapped hole 122. The decorative cover 15 is fixed on a side of the adapter 12 opposite to the image capture device 1. The decorative cover 15 is fixed to the adapter 12 by an adhesive, locking, latching, or co-molding method. The aforementioned methods are prior art and will not be described in details. It is noteworthy that the decorative cover 15 can further include a blocking cover 152 movably installed at a position proximate to the through hole 151 and has a shape corresponding to the shape of the through hole 151, to cover the through hole 151 by pressing or snapping, so as to achieve the effect of inhibiting dusts or foreign substances from entering into the input/output module 17 through the through hole 151 and the tripod tapped hole 122.

In other words, when the image capture device 1 is not installed onto the tripod 2, the adapter 12 is turned to the first position 13. Now, both of the adapter 12 and the decorative cover 15 are situated in the recession 101 and cover the input/output module 17 to achieve the effect of resisting dusts, foreign substances and water. When a user wants to install the image capture device 1 onto the tripod 2, the user can apply a force to turn the adapter 12 and move the adapter 12 to the second position 14. Now, the tripod tapped hole 122 is situated at an outer side of the image capture device 1, and the user can lift open the blocking cover 152 to expose the through hole 151 and the tripod tapped hole 122, and then the user passes the stud 21 of the tripod 2 through the through hole 152 and screws and couples the stud 21 into the tripod tapped hole 122 to install the image capture device 1 onto the tripod 2 to facilitate capturing images.

In summation of the description above, the image capture device and the mask structure thereof according to the present invention with the design of the adapter capable of selectively moving to a first position and a second position, such that when the adapter is situated at the first position, the adapter can be stored; and when the adapter is situated at the second position, the tripod tapped hole of the adapter is situated on an outer side of the image capture device. Now, the image capture device can be installed onto the tripod through the tripod tapped hole, so as to reduce the required space for the design and achieve the effect of miniaturizing the product. On the other hand, the adapter is installed at a position corresponding to the input/output module, so that the adapter can be applied to an interface blocking cover locked to the tripod, so as to improve the practical application.

While the invention has been described by means of specific embodiments, numerous modifications and variations could be made thereto by those skilled in the art without departing from the scope and spirit of the invention set forth in the claims.

What is claimed is:

1. An image capture device, comprising:
a casing;
a hinge module, installed in the casing, and having an end sticking out of the casing; and
an adapter, having an end disposed at the end of the hinge module, and a tripod tapped hole formed proximate to the other end of the adapter;
wherein when the adapter moves from a first position to a second position, the image capture device can be screwed and coupled to a tripod through the tripod tapped hole.

2. The image capture device of claim 1, further comprising a decorative cover having a through hole corresponding to the tripod tapped hole and formed on a side of the adapter, wherein the decorative cover and the casing are disposed on opposite sides of the adapter respectively.

3. The image capture device of claim 2, wherein the decorative cover includes a blocking cover movably and pivotally installed to a side screwed and coupled to the tripod, and the blocking cover has a shape corresponding to the shape of the through hole.

4. The image capture device of claim 1, further comprising an image capture button installed on a side of the casing, wherein the hinge module and the image capture button are disposed on the same side of the casing.

5. The image capture device of claim 1, wherein the casing has a recession, and the adapter is situated at the recession when the adapter is situated at the first position.

6. The image capture device of claim 1, wherein when the adapter is situated at the first position, the tripod tapped hole is situated on an inner side of the casing, and when the adapter is situated at the second position, the tripod tapped hole is disposed on an outer side of the casing.

7. A mask structure, applied in an image capture device, comprising:
a hinge module, installed in the image capture device, and proximate to an input/output module of the image capture device, and an end of the hinge module sticking out of the image capture device; and
an adapter, having an end disposed at the end of the hinge module, and a tripod tapped hole formed proximate to the other end of the adapter,
wherein when the adapter moves from a first position to a second position, the image capture device can be screwed and coupled to a tripod through the tripod tapped hole, and when the adapter is situated at the first position, the adapter covers the input/output module.

8. The mask structure of claim 7, further comprising a decorative cover having a through hole corresponding to the tripod tapped hole and installed on a side of the adapter, wherein the decorative cover and the image capture device are disposed on both sides of the adapter respectively, and the decorative cover has a blocking cover movably and pivotally installed to a side screwed and coupled to the tripod, and the blocking cover has a shape corresponding to the shape of the through hole.

9. The mask structure of claim 7, wherein the hinge module is installed on a side inside the image capture device, and disposed on the same side of an image capture button of the image capture device.

10. The mask structure of claim 7, wherein the image capture device has a recession formed proximate to the input/output module, and when the adapter is situated at the first position, the adapter is situated at the recession.
